(19) United States
(12) Patent Application Publication
(10) Pub. No.: US 2007/0011613 A1
(43) Pub. Date: Jan. 11, 2007

(54) Automatically displaying application-related content

(75) Inventors: Lisa M. Lane, Bellevue, WA (US); Ana M. Arellano Lopez, Sammamish, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/176,031

(22) Filed: Jul. 7, 2005

(51) Int. Cl. G06F 17/00

(52) U.S. Cl. 715/709

(57) ABSTRACT

An engine automatically generates links to relevant information, and displays those links on a display of an application. The content represented by the links can be filtered based on user-scoped filters, and the particular links displayed can be displayed based on a context within which the user is currently working.

### BACKGROUND

Computer users often spend a relatively large amount of time researching different software applications, before purchasing and deploying one. This can be particularly true where the user is associated with a business, and where the application is a business application, such as an accounting application, a sales or inventory application, or another application involved in providing a software solution to the needs of a business.

However, once users have purchased and deployed an application, many users do not take the time to review any related information. For instance, after an application is deployed, the software developer that developed the application may have important enhancements or other follow-up information which would be very useful to the user. However, in current systems, in order to obtain that information, the user must conduct a separate internet search, using the user's own search terms, in order to locate desired, relevant information.

Similarly, a user can attempt to obtain this type of information by performing other types of research into documentation provided by the software developer. However, this can be time consuming and difficult, and users simply tend not to do it. Therefore, many users of applications do not use those applications to their fullest extent.

It is also common for users to contact customer support services at the software vendor that developed the application, to have questions answered. Many times, there are certain questions related to a given application that are asked most frequently. Sometimes, the software vendor will thus develop written documentation answering these most frequently asked questions.

Currently, however, in order for a user to access this type of documentation, the user must conduct a separate search to locate that documentation. Again, users often simply do not do this because it can be time consuming and cumbersome.

The present invention addresses one, some or all of these problems or different ones. The background is provided by way of example only and is not to limit the scope of the present invention in anyway.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An engine automatically generates links to relevant information, and displays those links on a display of an application. The content represented by the links can be filtered based on user-scoped filters, and the particular links displayed can be displayed based on a context within which the user is currently working.

### BRIEF DESCRIPTION OF THE DRAWINGS

FIG. 1 illustrates one illustrative environment in which the present invention can be employed.

FIG. 2 is a block diagram of one illustrative embodiment of a link generation system.

FIG. 3 is a flow diagram illustrating the overall operation of the system shown in FIG. 2.

FIG. 4 is a flow diagram illustrating one illustrative embodiment for registration with a link generation system.

FIGS. 5-9 illustrate exemplary user controls, with links, corresponding to a plurality of different contexts.

### DETAILED DESCRIPTION

The present invention relates to displaying relevant information to a user of an application. However, before describing the present invention in more detail, one illustrative environment in which the present invention can be employed will be discussed.

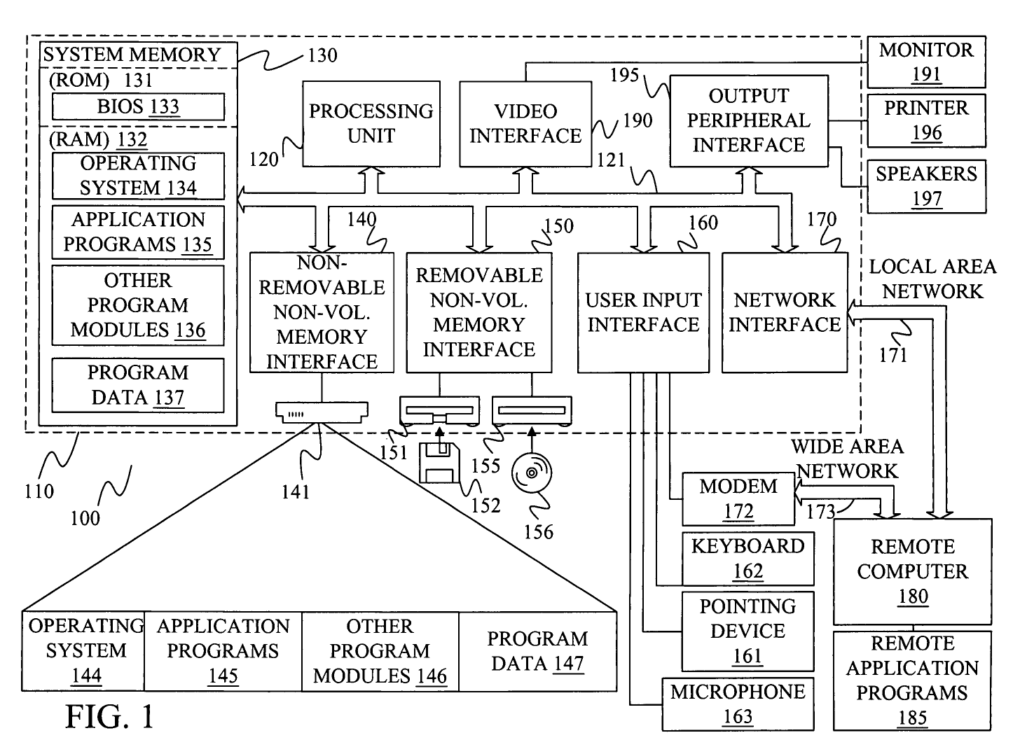

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

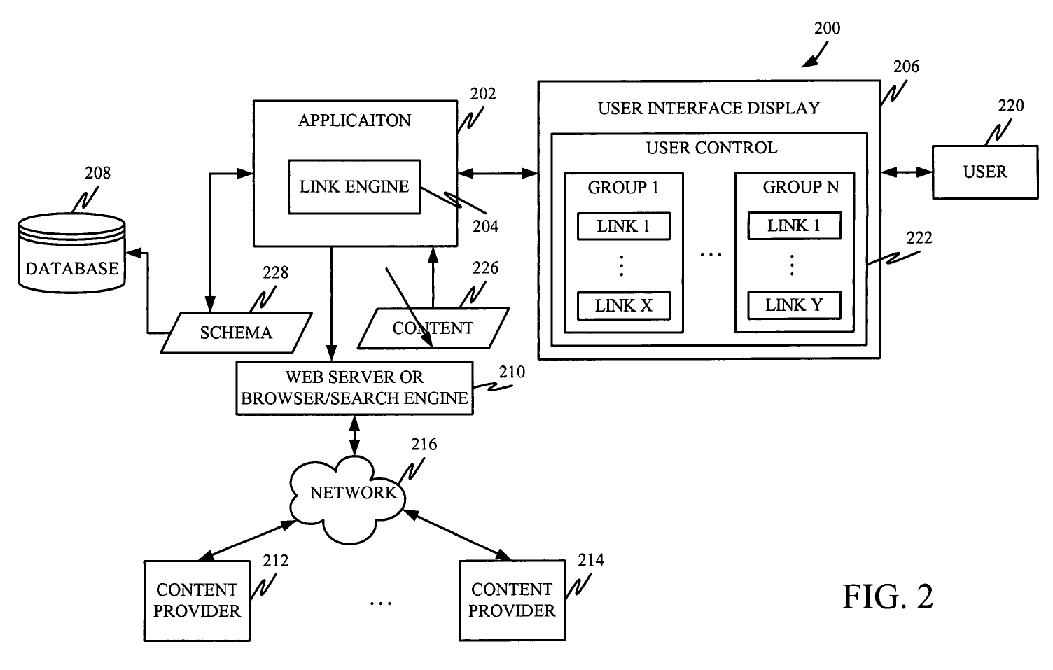

FIG. 2 illustrates one embodiment of a link generation system 200. Link generation system 200 includes application 202 which, itself, includes link engine 204, and produces a user display 206. System 200 is also shown having access to database 208 and web service or search engine 210, which searches content provided by content providers 212 and 214 over a network 216.

Application 202 is illustratively a business application, such as an accounting application or another financial application, or any other type of business application used in providing a software solution to a business. A user 220 illustratively interacts with application 202 through a user interface illustratively provided on user interface display 206. In doing so, user 220 can interact with application 202 in any of a wide variety of customary ways, such as by using a keyboard, a mouse, a speech recognition system, etc.

In operation, user 220 interacts with application 202 through user interface display 206 to perform any of a number of different tasks facilitated by application 202. Link engine 204 uses web server 210 to search content of content providers 212-214 to find information which may be useful to user 220 in using application 202.

Link engine 204 provides selectable links to that content on user interface display 206, such that the user can simply select one of those links and view the content. In one embodiment, the links are provided as a user control 222. An exemplary control is a Windows Forms user control. Thus, the user simply needs to actuate one of the links on user control 222 to view the relevant information provided by link engine 204.

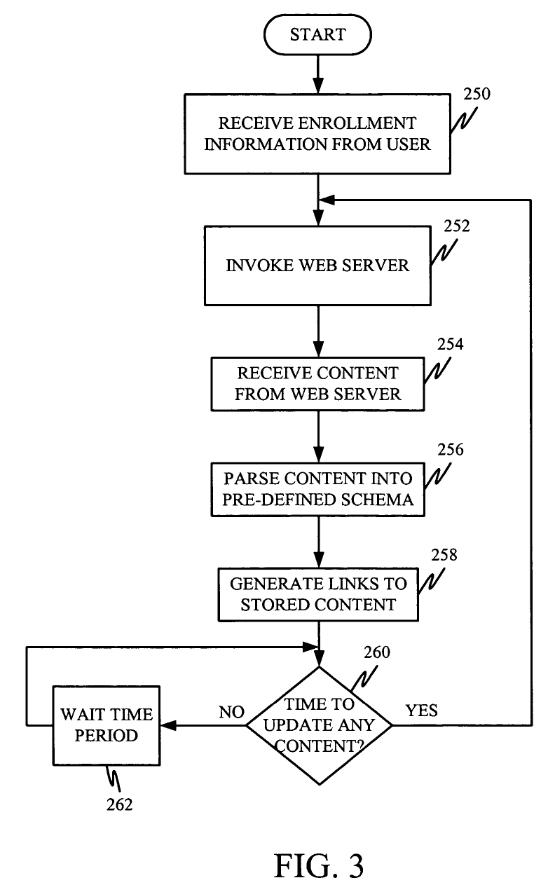

FIG. 3 is a flow diagram better illustrating the overall operation of system 200 in more detail. To initiate operation of link generation system 200, user 220 illustratively provides enrollment or registration information to link engine 204 through user interface display 206. This is indicated by block 250 in FIG. 3. The process of registering with link generation system 200 can take a wide variety of forms. For instance, in one embodiment, user 220 provides enrollment information relative to the company in which application 202 is implemented, such as the size of the company, the industry type (e.g., manufacturing, services, professional services, etc . . . ).

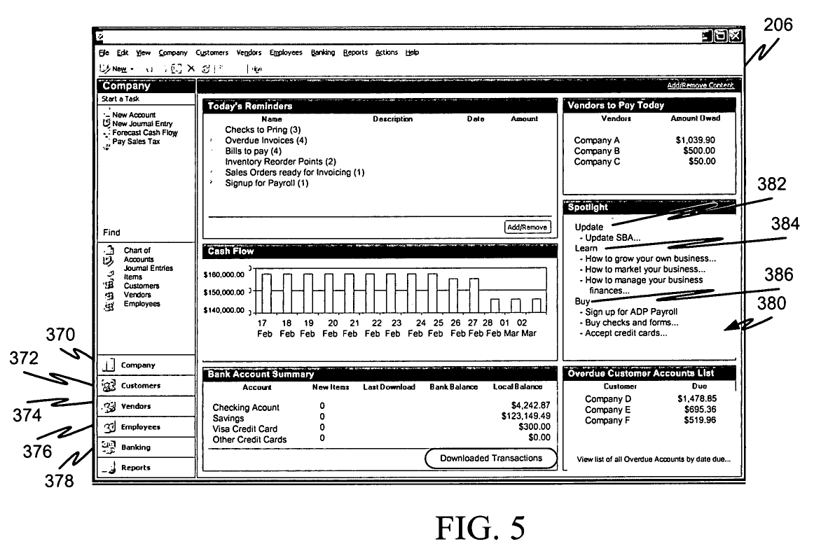

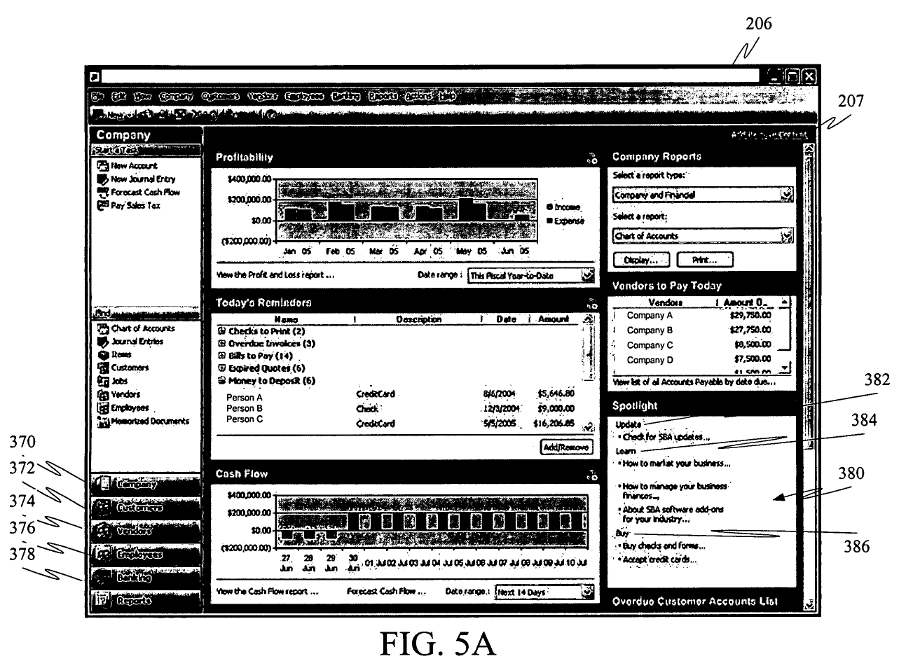

Link engine 204 receives registration information and invokes web server 210 to locate relevant information through network 216 from content providers 212-214. In one embodiment, application 202 can be divided into business entities or business tasks or other groups under which the links generated by link engine 204 can be grouped. This is indicated in more detail below with respect to FIGS. 5-9. However, assume for the sake of example that application 202 allows user 220 to view customers, vendors and sales orders. For each of those groups there may be relevant information which user 220 might be interested in, when viewing information associated with those groups. Thus, the groups provide a context within which link engine 204 can search for relevant data, or filter relevant data received in response to a search.

Link engine 204 thus invokes web service 210. Invoking the web service is indicated by block 252 in FIG. 3.

Web service 210, in turn, searches for relevant content from content providers 212-214, over network 216. In one embodiment, at least one of the content providers 212-214 is the vendor or developer that developed application 202. When launching a search for content, link engine 204 may thus illustratively provide web service 210 with the version number of application 202. This will illustratively help web service 210 find information relative to the particular version of application 202 being used by user 220. In that instance, relevant information may include updates to application 202, help information to address outstanding issues or bugs in application 202, articles relevant to the application or the business using the application, news about web services, critical fixes, service packs, etc., all of which may be of interest to user 220. Of course, content providers 212-214 need not be the developer of software application 202, but may be content providers that simply provide content that may be of interest to user 220.

In any case, web service 210 searches for and receives content and provides the content 226 to link engine 204 in application 202. Receiving the content from the search engine is indicated by block 254 in FIG. 3.

Link engine 204 parses content 226 into a predefined schema 228. In one embodiment, the predefined schema 228 is an XML schema that includes various content fields into which the content items (or links to the content) are parsed, as well as a time stamp field and a frequency field. As discussed below, the time stamp and frequency are used to determine whether that information needs to be updated. One illustrative embodiment of a schema is set out in Table 1 below. Parsing the content into a predefined schema 228 is indicated by block 256 in FIG. 3. Links are then generated for the content in the schema 228. The groups and link, and the corresponding textual title for them, can be dynamically generated by link engine 204, based on the content. Generating the links to the stored content is indicated by block 258 in FIG. 3.

```
TABLE 1
<SBAHeadlines xmlns:xsd=“http://www.w3.org/2001/XMLSchema”
xmlns:xsi=“http://www.w3.org/2001/XMLSchema-instance”
Timestamp=“632503894749330000” Frequency=“60”>
  <Block Type=“Company”>
    <Section Title=“Update”>
      <Headline Title=“Check for SBA updates...” Link=“http://office.microsoft.com/en-
us/officeupdate/default.aspx” Description=“” Expires=“0” />
    </Section>
    <Section Title=“Learn”>
      <Headline Title=“How to grow your business...”
Link=“http://www.microsoft.com/smallbusiness/gtm/grow/hub.mspx” Description=“ ”
Expires=“0” />
      <Headline Title=“How to market your business...”
Link=“http://www.microsoft.com/smallbusiness/issues/marketing/hub.mspx” Description=“”
Expires=“0” />
      <Headline Title=“How to manage your business finances...”
Link=“http://www.microsoft.com/smallbusiness/issues/finance/hub.mspx” Description=“”
Expires=“0” />
    </Section>
    <Section Title=“Buy”>
      <Headline Title=“Sign up for ADP payroll...”
Link=“http://ulogin.bcentral.com/adpconnector/go.aspx” Description=“” Expires=“0” />
      <Headline Title=“Buy checks and forms...”
Link=“http://www.microsoftchecksandforms.com” Description=“” Expires=“0” />
      <Headline Title=“Accept credit cards...”
Link=“http://ulogin.bcentral.com/magellan/creditcard.aspx” Description=“” Expires=“0” />
    </Section>
  </Block>
  <Block Type=“Customer”>
    <Section Title=“Update”>
      <Headline Title=“Check for SBA updates...” Link=“http://office.microsoft.com/en-
us/officeupdate/default.aspx” Description=“” Expires=“0” />
    <Section>
    </Section Title=“Learn”>
      <Headline Title=“How to acquire new customers...”
Link=“http://www.microsoft.com/smallbusiness/issues/marketing/customer_service_acquisition/
hub.mspx” Description=“” Expires=“0” />
      <Headline Title=“How to market online...”
Link=“http://www.microsoft.com/smallbusiness/issues/marketing/online_marketing/hub.mspx”
Descriptian=“” Expires=“0” />
      <Headline Title=“How to improve customer relations...”
Link=“http://www.microsoft.com/smallbusiness/issues/management/customer_relations/hub.mspx”
Description=“” Expires=“0” />
    </Section>
    <Section Title=“Buy”>
      <Headline Title=“Sell online...”
Link=“http://www.microsoft.com/smallbusiness/products/online/cm/detail.mspx”
Description=“” Expires=“0” />
      <Headline Title=“Send Email newsletters...”
Link=“http://www.microsoft.com/smallbusiness/products/online/lb/detail.mspx” Description=“”
Expires=“0” />
      <Headline Title=“Setup a Live Meeting...”
Link=“http://www.microsoft.com/office/livemeeting/prodinfo/default.mspx” Description=“”
Expires=“0” />
    </Section>
  </Block>
  <Block Type=“Vendor”>
    <Section Title=“Update”>
      <Headline Title=“Check for SBA updates...” Link=“http://office.microsoft.com/en-
us/officeupdate/default.aspx” Description=“” Expires=“0” />
    </Section>
    <Section Title=“Learn”>
      <Headline Title=“How to save big by sharing office costs...”
Link=“http://www.microsoft.com/smallbusiness/issues/finance/budgeting_expenses/save_big_by_sharing_business_costs.mspx”
Description=“” Expires=“0” />
      <Headline Title=“How a private Web site can help your business...”
Link=“http://www.microsoft.com/smallbusiness/issues/technology/business_software/how_private_web_site_could_help_your_business.
mspx” Description=“” Expires=“0” />
      <Headline Title=“How to manage your business travel...”
Link=“http://www.microsoft.com/smallbusiness/issues/finance/business_travel/hub.mspx”
Description=“” Expires=“0” />
    </Section>
    <Section Title=“Buy”>
      <Headline Title=“Buy checks and forms...”
Link=“http://www.microsoftchecksandforms.com” Description=“” Expires=“0” />
      <Headline Title=“Bank online...” Link=“http://ulogin.bcentral.com/magellan/bank.aspx”
Description=“” Expires=“0” />
      <Headline Title=“Share documents...”
Link=“http://www.microsoft.com/smallbusiness/products/online/sp/detail.mspx” Description=“”
Expires=“0” />
    </Section>
  </Block>
  <Block Type=“Employee”>
    <Section Title=“Update”>
      <Headline Title=“Check for SBA updates...” Link=“http://office.microsoft.com/en-
us/officeupdate/default.aspx” Description=“” Expires=“0” />
    </Section>
    <Section Title=“Learn”>
      <Headline Title=“How to recruit new employees...”
Link=“http://www.microsoft.com/smallbusiness/issues/management/recruiting_staffing/hub.mspx”
Description=“” Expires=“0” />
      <Headline Title=“How to manage employee benefits...”
Link=“http://www.microsoft.com/smallbusiness/issues/management/pay_benefits/hub.mspx”
Description=“” Expires=“0” />
      <Headline Title=“How to improve employee relations...”
Link=“http://www.microsoft.com/smallbusiness/issues/management/employee_relations/hub.mspx”
Description=“” Expires=“0” />
    </Section>
    <Section Title=“Buy”>
      <Headline Title=“Sign Up for ADP payroll...”
Link=“http://ulogin.bcentral.com/adpconnector/go.aspx” Description=“” Expires=“0” />
      <Headline Title=“Buy checks and forms...”
Link=“http://www.microsoftchecksandforms.com” Description=“” Expires=“0” />
      <Headline Title=“Share documents...”
Link=“http://www.microsoft.com/smallbusiness/products/online/sp/detail.mspx” Description=“”
Expires=“0” />
    </Section>
  </Block>
  <Block Type=“Banking”>
    <Section Title=“Update”>
      <Headline Title=“Check for SBA updates...” Link=“http://oflice.microsoft.com/en-
us/officeupdate/default.aspx” Description=“” Expires=“0” />
    </Section>
    <Section Title=“Learn”>
      <Headline Title=“How to get financing for your business...”
Link=“http://www.microsoft.com/smallbusiness/issues/finance/getting_financing/hub.mspx”
Description=“” Expires=“0” />
    <Headline Title=“How to improve your cash flow...”
Link=“http://www.microsoft.com/smallbusiness/issues/finance/budgeting_expenses/7_ways_to_improve_your_cash_flow.mspx”
Description=“” Expires=“0” />
      <Headline Title=“How to make a budget work...”
LinK=“http://www.microsoft.com/smallbusiness/issues/finance/budgeting_expenses/8_ways_to_make_a_budget_work.mspx”
Description=“” Expires=“0” />
    </Section>
    <Section Title=“Buy”>
      <Headline Title=“Bank online...” Link=“http://ulogin.bcentral.com/magellan/bank.aspx”
Description=“” Expires=“0” />
      <Headline Title=“Buy checks and forms...”
Link=“http://www.microsoftchecksandforms.com” Description=“” Expires=“0” />
      <Headline Title=“Accept credit cards...”
Link=“http://ulogin.bcentral.com/magellan/creditcard.aspx” Description=“” Expires=“0” />
    </Section>
  </Block>
</SBAHeadlines>
```

The links and the parsed data are then stored in database 208 for later retrieval by link engine 204. In one embodiment, when retrieved, the links are provided to the user on user interface display 206 as a user control 222. The links can be grouped into groups (such as groups 1-N shown in FIG. 2), and each group can contain a number of different links (such as links 1-X in group 1 and links 1-Y in group N shown in FIG. 2).

Link engine 204 periodically examines the content stored in database 208 to determine whether the data needs to be updated. In one illustrative embodiment, link engine 204 simply examines the time stamp and frequency fields in the stored schemas 228 to determine whether the associated content must be updated. The time stamp may illustratively indicate the data and time at which the content in the associated content field was received from search engine 210. The frequency field will illustratively indicate how often that content field is to be updated. Link engine 204 can then simply determine, based on the time stamp and frequency information, whether that content needs to be updated. Determining whether the content needs to be updated is indicated by block 260 in FIG. 3. If so, processing reverts back to block 252 where link engine 204 again invokes web service 210, using the relevant context or filter data, as well as possibly the enrollment data, in order to update the content.

If, at block 260, it is not time to update any of the content, then link engine 204 simply waits for a desired time period before checking the time stamp and frequency fields again, this is indicated by block 262 in FIG. 3.

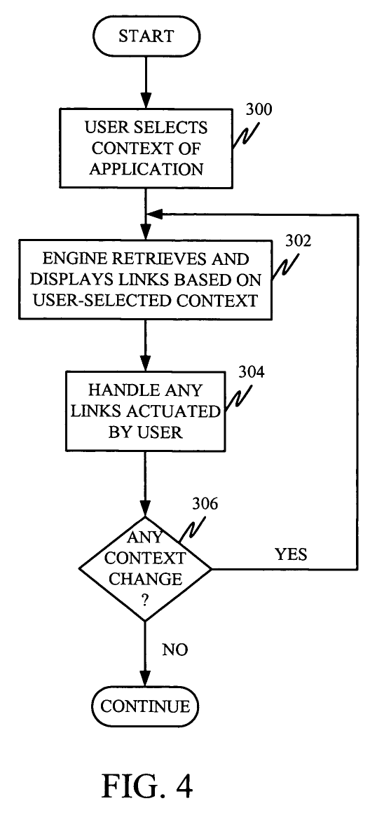

Before describing exemplary groups and links used in accordance with one embodiment of the present system, the runtime operation of system 200 will be described. FIG. 4 is a flow diagram illustrating runtime operation in more detail.

User 220 first selects a context in application 202. This is indicated by block 300 in FIG. 4. In one illustrative embodiment, the user 220 selects the context by simply selecting a group of data to be displayed. A group of data may correspond to company, customers, vendors, employees, etc.

In response to the user selecting a context, link engine 204 accesses database 208, filters the links based on context and retrieves the links corresponding to the selected context. Those links are displayed, illustratively in the form of user control 222, on user interface display 206. Retrieving and displaying the links associated with the user-selected context is indicated by block 302 in FIG. 4.

Link engine 204 then simply waits for user 220 to invoke, or actuate, any of the links on user control 222. If the user does actuate such a link, link engine 204 either retrieves the content or data associated with that link from database 208 or navigates the user to a URL specified by the link, either by opening a separate window or by replacing a current window. Handling user-actuated links is indicated by block 304 in FIG. 4.

Link engine 204 is always made aware if the user 220 changes the context of application 202. If the user does change the context by selecting another group of data for display, processing reverts to block 302 where link engine 204 retrieves the links associated with the new context, and handles any links actuated by the user, as indicated by block 304. Determining whether the context has changed is indicated by block 306 in FIG. 4.

FIGS. 5 and 5A show two exemplary embodiments of user interface display 206. FIGS. 5 and 5A shows that the application 202 generating display 206 divides the application into groups of viewable information. The groups are found in the lower left hand corner of the display 206 shown in FIGS. 5 and 5A. The groups in the exemplary embodiment shown in FIGS. 5 and 5A include a company group 370, customer group 372, vendor group 374, employee group 376 and banking group 378. By actuating any of these group buttons, the data displayed on at least a portion of display 206 changes.

It can be seen in FIGS. 5 and 5A that the user has illustratively selected the company group 370, because at the top of the left hand column on display 206, the heading Company is displayed. The display also shows various sections with information relating to the company, such as reminders, cash flow, bank account summary, vendors to pay, and overdue customer accounts.

Display 206 also has a portion 380 labeled “Spotlight”. Portion 380 shows that, for the context of Company selected by the user, there are three groups of links. Those groups are represented by Update group 382, Learn group 384 and Buy group 386. Each of the groups 382-386 has one or more actuable links beneath it in section 380 of display 206. The Update group may illustratively include links about updates to the application 202. The links under the Learn group may illustratively identify the most commonly raised issues with user support and present to the user, when the link is actuated, articles (or other documentation) that address those issues. Also, in one embodiment, for the Buy group, the links may identify a variety of different web services that will complement, and integrate with, the information currently displayed in the selected context.

For instance, in the example shown in FIG. 5, under the Update group 382, there is a single link labeled “Update”. Under the Learn link 384, there are three links labeled “How to grow your business . . . ”, “How to market your business . . . ”, and “How to manage your business finances . . . ”. Similarly, under the Buy group 386, there are three links labeled “Sign up for payroll . . . ”, “Buy checks and forms . . . ”, and “Accept credit cards . . . ”. FIG. 5A has a number of other links.

It will be appreciated, of course, that the text associated with any group or link can be dynamically modified, as can the number of groups, based on the content displayed. Similarly, the number of links within each group can vary based upon the results of the search conducted to obtain content for that group.

In one illustrative embodiment, XML format is used and the groups are predefined within the XML format, but the number and text associated with the links can be changed dynamically.

Also, in accordance with one embodiment, where no relevant information has been found for a given group, a default text will be placed in the group. The default text illustratively indicates that no information is available, or inquires whether the user wishes to conduct a search, or the default text may simply be one or more desired default links to default content.

In one embodiment, display 206 also allows a user to add or remove portion 380 from display 206. By actuating the Add/Remove content button 207, the user can toggle between having portion 380 shown or not shown on display 206.

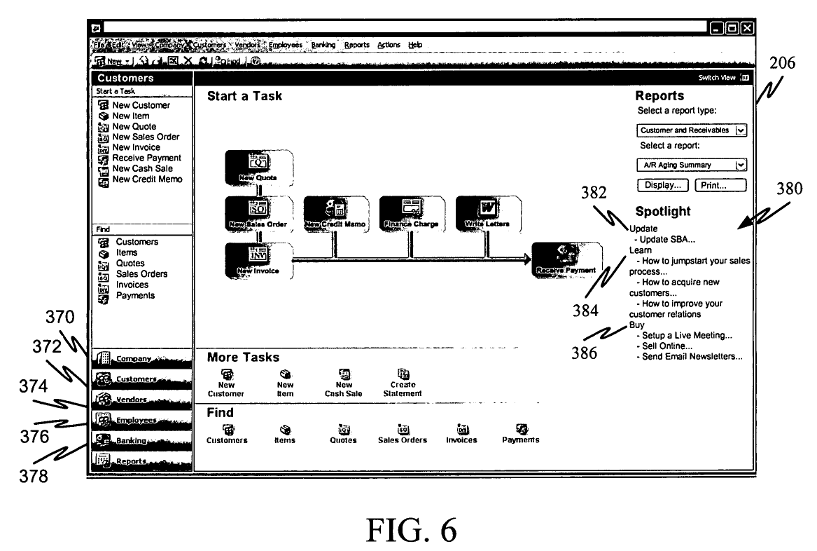

FIG. 6 illustrates another exemplary embodiment of user interface display 206. The display in FIG. 6 is somewhat similar to the exemplary display shown in FIG. 5, and similar items are similarly numbered. However, in FIG. 6 the Customers button 372 has been selected by the user. Therefore, the portion 380 of user interface display 206 has been modified to reflect the new context selected by the user.

Portion 380 in FIG. 6 shows that the groups are still the same as that shown in FIG. 5. However, the individual links within those groups have changed somewhat. The link under the Update group 382 is the same, because that link simply illustratively relates to updating the application 202 generating display 206. However, the links under the other two groups 384 and 386 have changed to be more relevant to the Customers context which has now been selected by the user.

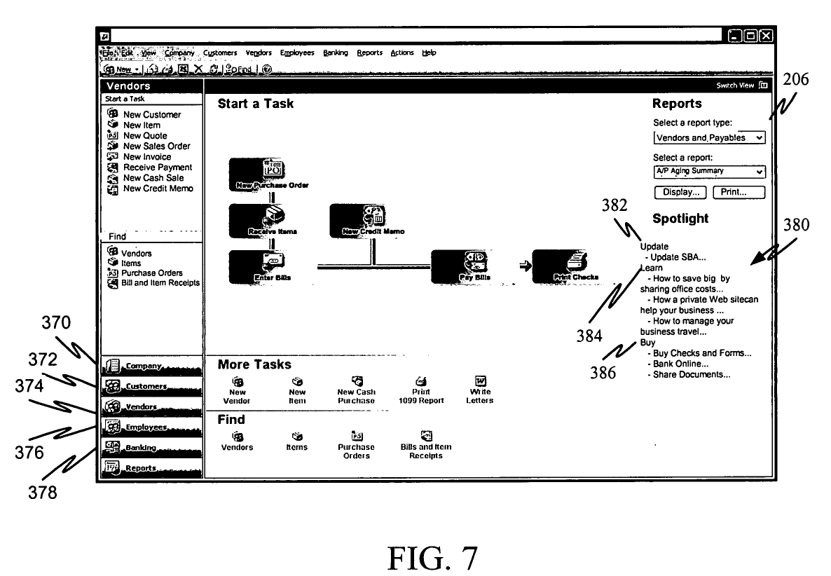

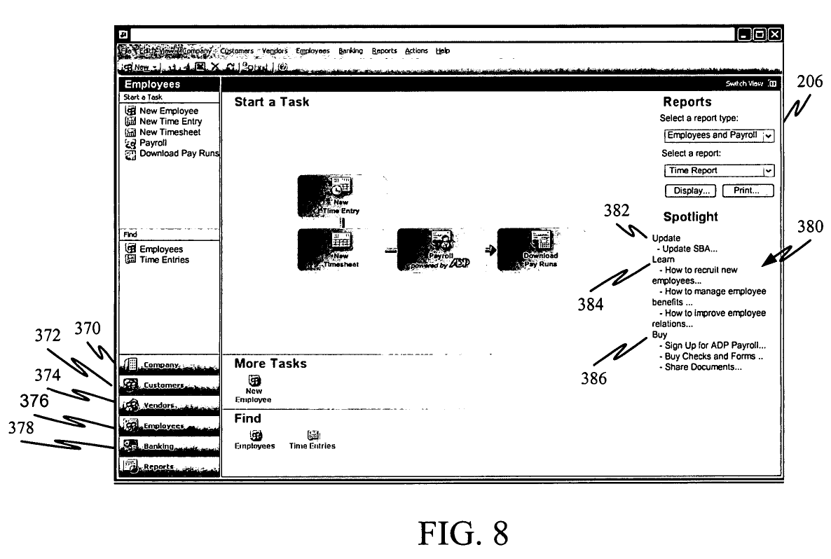

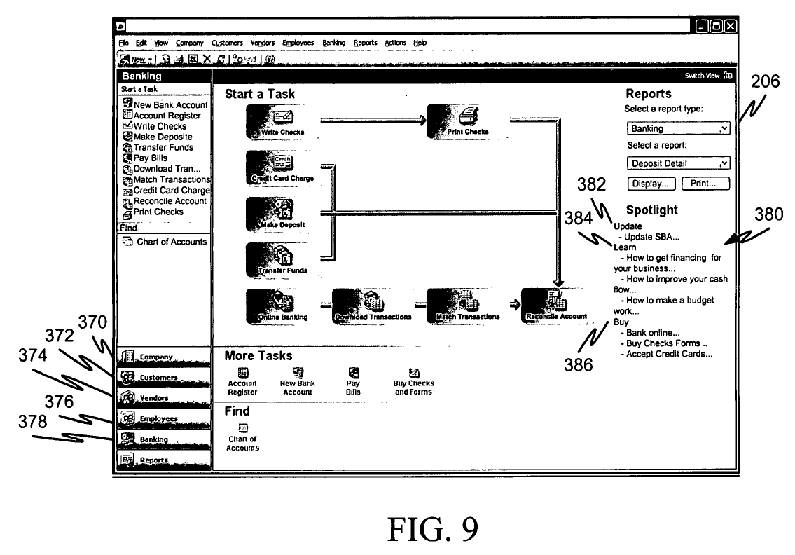

FIGS. 7, 8 and 9 are similar to FIG. 6, except that the user has again selected a different context in each of those Figures. In FIG. 7, the user has selected the Vendors context. In FIG. 8, the user has selected the Employees context, and in FIG. 9, the user has selected the Banking context. It can be seen that, in each of those different contexts, link engine 204 has retrieved a different set of links and displayed them in the different groups on the user control 222 in portion 380 of display 206.

It can thus be seen that one embodiment of the present system can be used to push content of interest to the user, without the need for the user to conduct a separate search, or do any other research. The content of interest can be specific to the context within which the user is working. The content can be pushed to the user on substantially any display generated by the application. In one embodiment, the content is pushed on a main display screen associated with a given group of information displayed by the application. Of course, it will also be noted that the groups can be defined in any desired way, and those shown and described herein are illustratively only.

In addition, the content provided to the user through the generated links can be any desired content. It can be content which is believed to be of interest to the user, it can be content which is related to the application used by the user, it can be content which the manufacturer of the application or other content provider desires to have before the user in the selected context, or it can be any other desired information. The content can be located over a wide area network (such as the internet) or a local area network or simply by accessing a local database, otherwise. This makes it very easy for the user to view and take advantage of this information, without extra work on the part of the user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of displaying content to a user of an application, comprising:
identifying relevant content based on application-related information indicative of characteristics of the application;
generating actuable links to the relevant content;
dividing the actuable links into divisions based on user-selectable contexts in the application; and
displaying a division of links on a display of the application based on a currently selected context.

2. The method of claim 1 and further comprising:
receiving filter information from the user; and wherein identifying comprises identifying relevant content based on the filter information.

3. The method of claim 1 wherein the application is a business application and wherein receiving filter information comprises receiving information related to a business deploying the application.

4. The method of claim 3 wherein receiving filter information comprises receiving information indicative of a size and type of the business deploying the application.

5. The method of claim 1 wherein generating actuable links comprises:
parsing portions of the relevant content into a predefined schema; and
storing the schema.

6. The method of claim 1 wherein dividing the actuable links comprises:
dividing the actuable links based on whether the relevant content for a corresponding actuable link relates to a context.

7. The method of claim 1 and further comprising:
dividing the each division of actuable links into a plurality of groups, each group being related to a context of the application associated with the division of actuable links.

8. The method of claim 1 wherein the characteristics of the application comprise a version number of the application, and wherein identifying relevant information comprises:
identifying relevant information based on the version number of the application.

9. The method of claim 1 and further comprising:
receiving a context change indicator indicative of the user selecting a new context;
retrieving links corresponding to the new context; and
displaying the retrieved links.

10. The method of claim 1 wherein displaying a division of links comprises:
displaying the actuable links as user controls on the display of the application.

11. The method of claim 1 wherein identifying relevant content comprises:
identifying one or more of updates to the application, web services related to the application, service packs related to the application, critical fixes for the application, documents describing features of the application, documents regarding frequently asked service questions, documents related to a business deploying the application, and documents related to the contexts of the application.

12. The method of claim 1 and further comprising:
intermittently repeating the step of identifying relevant content, to update the relevant content identified.

13. A user interface for an application, comprising:
a context selection portion including a plurality of user-selectable context identifiers, each context identifier representing a different context in the application;
a first display portion displaying information from the application based on a selected context identifier; and
a link display portion displaying actuable links to associated relevant content external to the application, the displayed actuable links changing based on changes in the selected context identifier.

14. The user interface of claim 13 wherein the link display portion displays the actuable links divided into different groups, based on a subject matter of the relevant content associated with the actuable links.

15. The user interface of claim 14 wherein at least one of the groups includes links to any updates to the application.

16. The user interface of claim 13 wherein the link display portion displays the actuable links as user controls.

17. A system for displaying content to a user of a business application, comprising:
a user interface displaying a plurality of selectable context indicators indicative of a plurality of different contexts of the business application, and information from the business application based on a selected context identifier; and
a link engine configured to identify relevant content, external to the business application, based on user input filter information and to generate links to the relevant content identified and to divide the links into divisions based on the different contexts of the business application, and wherein the user interface displays a division of links based on the selected context identifier.

18. The system of claim 17 wherein the link engine is configured to intermittently update the identified relevant content.

19. The system of claim 17 wherein the link engine is configured to identify relevant content based on a version of the business application.

20. The system of claim 17 wherein the link engine is configured to change a plurality of links provided to the user interface based on a change in the selected context identifier.
